(19) United States
(12) Patent Application Publication
(10) Pub. No.: US 2008/0032606 A1
(43) Pub. Date: Feb. 7, 2008

(54) METHOD FOR CONTROLLING THE DISHING PROBLEM ASSOCIATED WITH CHEMICAL-MECHANICAL PLANARIZATION (CMP) DURING MANUFACTURE OF COPPER MULTILAYER INTERCONNECTION STRUCTURES IN ULTRA LARGE-SCALE INTEGRATED CIRCUITS (ULSI)

(76) Inventors: Yuling LIU, Tianjin (CN); Xinhuan NIU, Tianjin (CN); Bomei TAN, Tianjin (CN); Yahong WU, Tianjin (CN); Bo LIU, Tianjin (CN); Xihui ZHANG, Tianjin (CN)

Correspondence Address: MATTHIAS SCHOLL, 14781 MEMORIAL DRIVE, SUITE 1319, HOUSTON, TX, 77079, US

(21) Appl. No.: 11/753,211

(22) Filed: May 24, 2007

(30) Foreign Application Priority Data
Jun. 9, 2006 (CN) 200610014300.0

(51) Int. Cl. B24B 1/00; C09K 13/00

(52) U.S. Cl. 451/36; 252/79.1

(57) ABSTRACT

Provided is a method of chemical-mechanical planarization of copper multilayer interconnection structures and of controlling the dishing problem associated therewith comprising: (a) preparing a slurry by (i) diluting SiO₂ hydrosol with deionized water; (ii) admixing a chelating agent and adjusting the pH to between 9.5 to 11.5; and (iii) admixing nonionic surfactant(s) and oxidant(s); (b) applying said slurry to said copper multilayer interconnection structures; and (c) polishing said copper multilayer interconnection structures with polishing pad(s). The flow speed is 200-5000 ml/min, the temperature is 20-40° C., the rotation speed is 60-120 rpm, the pressure is 100-250 g/cm², and the polishing speed can be 200-1100 nm/min. The process involves 1-5 min for polishing the copper and then 30-60 sec for polishing the copper, the barrier layer, and the dielectric layer. Consistent polishing speeds for the copper, the barrier layer, and the dielectric layer are achieved, which effectively reduces the dishing problem. At the same time, the method reduces the contamination of the surface with metal ions.

### CROSS-REFERENCE TO RELATED APPLICATIONS

Pursuant to 35 U.S.C. § 119 and the Paris Convention Treaty, this application claims the benefit of Chinese Patent Application No. 200610014300.0 filed Jun. 9, 2006, the contents of which are incorporated herein by reference.

### BACKGROUND OF THE INVENTION

1. Technical Field

This invention relates to a chemical-mechanical planarization technique, especially designed to control the dishing problem arising during the manufacture of copper multilayer interconnection structures in ultra large-scale integrated circuits.

2. Background of the Invention

As the integrated circuit density increases and the device feature size becomes smaller, the electrical resistance and capacitance of the metal are enhanced, which causes the interconnect delay time RC to increase and, hence, decreases the speed of the circuitry (R and C refer to metal wire resistance, and interlevel dielectric capacitance, respectively).

Because copper has higher resistance to electromigration, and lower resistivity and heat sensitivity than aluminum, it can reduce the RC delay time and raise circuital reliability. This characteristic makes it a good candidate for multilayer interconnections. However, the adhesion ability between copper and the dielectric layer is unstable, and copper easily diffuses into substances such as silicon and silicon dioxide, forming a deep energy level in these substances, which adversely affects the power characteristics of components.

To successfully accomplish copper metallization on silicon chips, barrier films need to be used to limit the mutual diffusion between copper and silicon. The Damascene process, which uses copper-CMP (Cu-CMP), is a mature technology that has been successfully applied for conductor patterning in integrated circuit manufacture. For getting an accurate photoetch pattern and optimum electrical properties in multilayer interconnection structures, the key to achieving success is to guarantee a global planarization of each level. Cu-CMP serves to remove the copper and the barrier layer to the top level of the insulating layer. At the same time, global and local planarization of the copper surface is realized.

The dishing problem, i.e., a polishing non-uniformity, occurring during Cu-CMP of multilayer interconnection structures in ULSI results in increased electrical noise, lack of uniform electrical characteristics, increased RC delay time, and has adverse effects on integration, reliability, and cost.

Because copper, tantalum, and the dielectric layer have different physical and chemical properties, if a single polishing slurry and polishing conditions are used for Cu-CMP, the polishing speeds will be different and the selection ratio will not be ideal for all substrates. Specifically, copper has a faster polish speed than the barrier layer material and the dielectric layer, contributing to the dishing problem during CMP and often bringing about a short circuit with catastrophic consequences.

Currently, the dishing problem is the most difficult challenge in Cu-CMP. Conventional Cu-CMP processes include the use of acidic slurries, followed by strong mechanical lapping, followed by additional applications of acidic slurries. However, the barrier layer (e.g., Ta, TaN, TiN) and the dielectric layer are more stable to acid than is copper, and if the above-mentioned method is employed, the polishing speeds of the barrier layer and the dielectric layer are too low, and the dishing problem is difficult to solve.

Cu-CMP polishing slurries can be divided into two major categories according to their pH value: acidic and alkaline. Conventionally acidic slurries have been used for Cu-CMP because acids easily dissolve copper. For example, nitric acid has been widely used in the process, as it easily reacts with copper to yield soluble cupric nitrate according to the following chemical equation:
3 Cu+8 HNO₃ (dilute)→3 Cu(NO₃)₂+2 NO+4 H₂O.
However, using nitric acid results in a poor selectivity between high and low spots, i.e., the removal speed at different locations of the surface is almost the same, making it difficult to achieve global planarization. FIG. 1 illustrates the dishing problem when nitric acid is used as the polishing slurry.

Chinese Patent No. CN1312845 calls for addition of benzotriazole (BTA) to an acid slurry to control dishing. The BTA reacts with copper and produces a Cu-BTA monolayer which can restrain the reaction of nitric acid with copper. Thus, the inner copper layer is not corrupted, the polishing speeds of the bulgy and concave copper surfaces are different, and as a result, planarization is achieved. However, it is difficult to achieve a high process speed when using BTA, and the speed attained is only about 70% of the speed that can be attained when BTA is not used.

When acidic polishing slurry is used, it is difficult to form a stable copper complex, and conversely it is easy to cause cupric ion pollution. In addition, the use of acidic slurry degrades the polishing equipment very rapidly. Finally, environmental pollution resulting from the use of the acidic slurry is a major concern, as is the operator's health. Conventional Cu-CMP processes also utilize EDTA or its disodium salt as the chelating agent. However, EDTA does not dissolve in water at low pHs, and its water-soluble disodium salt leads to metal ion contamination. Accordingly, much opportunity remains for improvement in the area of Cu-CMP.

### BRIEF SUMMARY OF THE INVENTION

In one aspect of this invention provided is a solution to the dishing problem. Specifically, a control method for the dishing problem arising during chemical mechanical polishing of copper multilayer interconnection in ULSI is provided.

In certain embodiments of the invention, the Cu-CMP features strong complexation, strong chemical action, no scratching, and low cost.

In certain embodiments of the invention, the polishing slurry comprises: SiO₂ hydrosol having different amounts of deionized water as the abrasive; a chelating agent that can chelate the metal ion at pH levels from 9.5 to 11.5; nonionic surfactant(s); and oxidizing agent(s).

In certain embodiments of the invention, the flow speed of the slurry is 200-5000 ml/min, the temperature is 20-40° C., the rotation speed of the polishing pads is 60-120 rpm, the pressure is 100-250 g/cm², and the polishing speed is 200-1100 nm/min. Under these conditions, the process involves 1-5 min of polishing the copper layer, followed by 30-60 sec of polishing the copper, the barrier layer, and the dielectric layer.

In certain embodiments of the invention, the abrasive is SiO₂ hydrosol having particle diameters ranging from 15-40 nm, and starting concentration ranging from 20-50 wt. %. This means that for each 100 g of undiluted SiO₂ hydrosol there is from 20 to 50 g of SiO₂ particles. The SiO₂ hydrosol is then further diluted with deionized water when the CMP slurry is prepared. The weight proportion between the abrasive and the added deionized water is from 1:1 to 1:5.

In certain embodiments of the invention, the metal ion chelating agent is a compound which can form a large-membered chelating ring with metal ions. Particularly, the metal ion chelating agent is a salt of EDTA with a 1,2-diaminoalkan(poly)ol. More particularly, the metal ion chelating agent is an EDTA salt formed with 4 equivalents of 3,4-diaminobutane-1,1,2,2-tetraol, also referred to herein as EDTA·4 3,4-diaminobutane-1,1,2,2-tetraol. In certain embodiments, the metal ion chelating agent is water soluble and assists in oxidation.

Under alkaline conditions, EDTA·4 3,4-diaminobutane-1,1,2,2-tetraol has a stable chelating effect on several different metals, and experimental results indicate that it reacts with metal ions yielding a water soluble complex. The volume percentage of a chelating agent is about 0.5-10% with respect to the volume of the slurry.

In certain embodiments of the invention, the nonionic surfactant is an alcohol ether surfactant, such as a fatty amine oxide (FA/O) surfactant, a JFC surfactant, a fatty alcohol ethoxylate (AEO) surfactant, a fatty amine ethoxylate surfactant, fatty alkanolamide surfactant, or derivatives thereof. The volume percentage of a nonionic surfactant is about 0.5-10% with respect to the volume of the slurry.

In certain embodiments of the invention, the oxidizing agent is an oxide, particularly a peroxide, and more particularly hydrogen peroxide (H₂O₂). The volume percentage of the oxidizing agent is 0.5-10% with respect to the volume of the slurry.

### BRIEF DESCRIPTION OF THE DRAWINGS

Below, the invention is explained in more detail with reference to accompanying drawings, in which:

FIG. 1 illustrates three stages of polishing of prior art leading to the dishing problem when an acidic polishing slurry is used;

FIG. 2 illustrates three stages of polishing according to one embodiment of the invention which controls the dishing problem; and

FIG. 3 illustrates the SiO₂ layer, the copper layer, and the tantalum barrier metal layer at the beginning and at the end of Cu-CMP according to one embodiment of the invention.

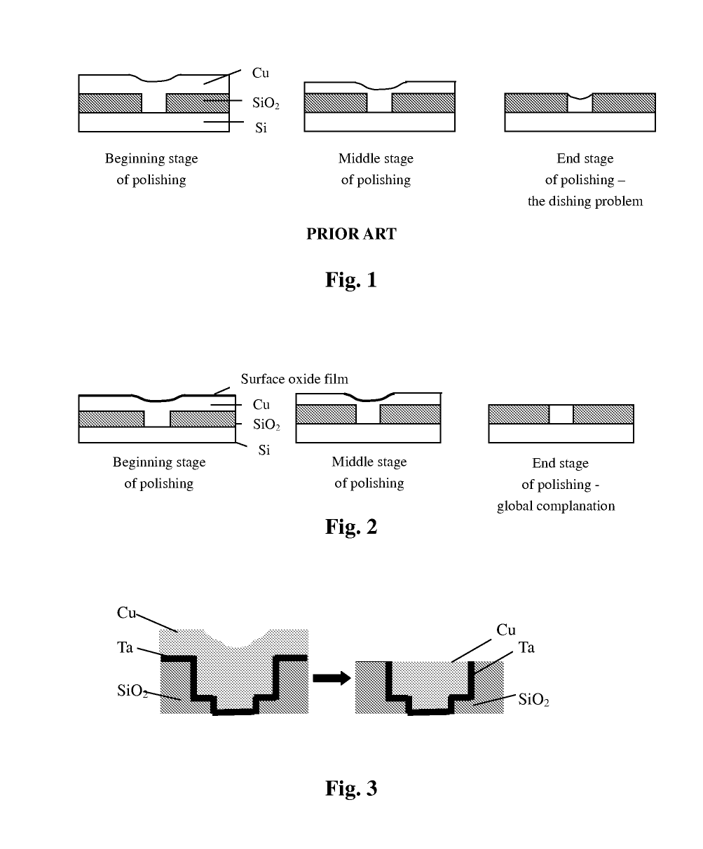

### DETAILED DESCRIPTION OF THE INVENTION

Cu-CMP according to the invention is conducted under high pressure, high-speed rotation of polishing pads, and alkaline conditions promoting strong complexation. Under these conditions, the barrier metal to be removed is transformed into a water-soluble complex, and the dielectric layer to be removed is transformed into an amine salt, which is water soluble. The materials that conventionally have a fast removal speed (such as copper) are converted into compounds that are difficult to dissolve in water. Without wishing to be bound by theory, this principle may be directly responsible for providing solution to the dishing problem.

Cu-CMP is performed under alkali condition, uses SiO₂ as the abrasive having particle diameters ranging from 15-40 nm, uses a surfactant and a chelating agent, and the pH is maintained in the range of 9.5-11.5.

The surfactant is an FA/O surfactant a polyoxyethylene ether surfactant, a non-ionic surfactant, or any other suitable surfactant. The FA/O surfactant is, for example, an alkyl phenol ethoxylate of the general Formula I, wherein R is an alkyl, and n is an integer greater than about 5; more particularly, R is an alkyl having at least 6 carbon atoms, and n is an integer from 7 to 10; and most particularly, R is a decyl and n is equal to 7 or 10.

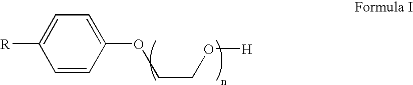

The polyoxyethylene ether surfactant is, for example, a fatty alcohol polyoxyethylene ether of the general Formula II, wherein R is an alkyl, and n is an integer greater than about 5; more particularly, R is an alkyl having at least 6 carbon atoms, and n is an integer from 10 to 25; and most particularly, R is a straight chain alkyl having from twelve to eighteen carbon atoms, and n is 15 or 20.

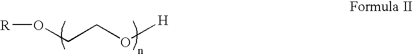

The chelating agent is, e.g., a water-soluble FA/O chelating agent. Particularly, EDTA·4 3,4-diaminobutane-1,1,2,2-tetraol of Formula III 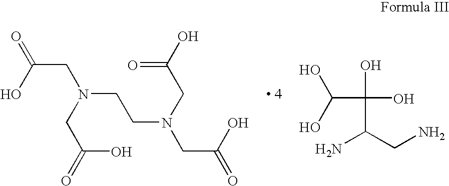
is used as a chelating agent. EDTA·4 3,4-diaminobutane-1,1,2,2-tetraol is a potent chelator for many metal ions, and it acts simultaneously as a buffer and an antioxidant. It is also relatively inexpensive.

Under certain process conditions, consistent polishing speeds of the copper, the barrier layer, and the dielectric layer are realized which effectively reduces the dishing problem, reduces cross-contamination of surfaces, and meets the needs of successful copper interconnections in the industry. The methods described herein can obtain near-perfect surface smoothness.

The method according to this invention uses an alkaline slurry that can achieve planarization of interconnections, high smoothness, good selectivity, low scratching, higher polishing speeds, effective control of metal ion contamination, lower concentration as compared with acid slurry, easy clean-up, and low environmental pollution.

Without wishing to be bound by theory, the following is a model mechanism of alkaline slurry for Cu-CMP:
(a) Under alkaline conditions, Cu(OH)₂ film is formed rapidly on copper surface under the action of an oxidizer, and, as a result, the inner layer of copper is shielded from further corrosion;
(b) During the polishing process, the bulgy place of the copper wire contacts the polishing pad under the conditions of high pressure and high speed rotation, and the superficial oxide film reacts with the chelating agent, forming a complex compound that is stable and insoluble. The copper complex compound is removed by the polishing pad and the abrasive. Then, the copper sub-layer is exposed and corroded, and a new oxide film forms. The oxide film is converted into a complex, repeating the process and achieving high polishing speed, high selectivity, and high smoothness; and
(c) The concave copper does not contact the polishing pad and the superficial oxide film is not destroyed. This protects the inner layer of copper from corroding further. Therefore, high selectivity is achieved. As shown in FIG. 2, the method according to this invention achieves global planarization and effectively solves the dishing problem.

The method according to this invention utilizes metal complexation under alkaline conditions. At these conditions, the chelating agent has a strong complexing action with respect to Cu, Ta barrier material, SiO₂ dielectric layer material, and the tungsten interlayer plug. The resultant complex, or the amine salt, is easily soluble in water, which improves the polishing speed. Under optimal conditions, it is possible to consistently achieve high polishing speeds for different materials, which helps to control the dishing pit appearance, as shown in FIG. 3.

The method according to this invention achieves high polishing speeds for copper, tantalum, and the dielectric layer, with polishing speeds in the range of 200-1100 nm/min. With reference to FIG. 2, the concave surface does not contact the polishing pad because the superficial Cu(OH)₂ oxide film is not destroyed, the inner layer copper is prevented from corroding, ensuring high selectivity, achieving global complanation, and effectively reducing the dishing problem. This method is suitable for copper wiring final polishing, and it allows for an effectively control of the small dishing pit appearance.

The invention will now be described in more detail with respect to the following, specific, non-limiting examples.

### EXAMPLES

In order to resolve the dishing pit problem, the copper wire CMP process can be divided into two steps, which are initial polishing and final polishing. The following abbreviations are used: FA/O I surfactant: compound of Formula I, 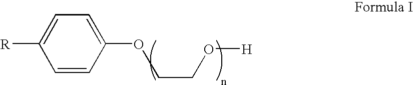
wherein R is a decyl and n is equal to 7; FA/O chelating agent: compound of Formula III, 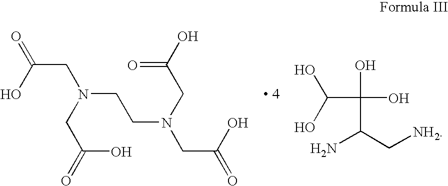
The compound of Formula III has been purchased from Tianjin Jingling Microelectronic Materials Limited Company and was sold under the brand name FA/O II chelating agent.

### Example 1

The polishing slurry and the polishing condition of the initial polishing and the final polishing are as follows.

For the initial polishing stage of Cu-CMP, the slurry characteristics are as follows: the SiO₂ sol abrasive size is 40 nm, the SiO₂ initial concentration is 40 wt. %, the proportion of SiO₂ abrasive to deionized water is 1:1, the FA/O I surfactant concentration is 50 ml/L of the slurry, the FA/O chelating agent concentration is 50 ml/L of the slurry, the pH ranges from 9.5-11.5, and the oxidant H₂O₂ concentration is 30 ml/L of the slurry. The polishing condition: pressure is 200 g/cm², the slurry flow is 200 ml/min, the rotation speed is 100 rpm, the temperature is 30° C., the polishing speed ranges between 200-1100 nm/min, and the polishing time is 1-5 min. The initial polishing speeds are exemplified in Table 1.

TABLE 1
The initial polishing speeds

| | #1 | #2 | #3 | #4 | #5 | #6 |
|---|---|---|---|---|---|---|
| | (Cu) | (Cu) | (Ta) | (Ta) | (SiO₂) | (SiO₂) |
| Before CMP (μm) | 73 | 81 | 60.54 | 60.53 | 78.524 | 68.532 |
| After-CMP (μm) | 65 | 74 | 60.50 | 60.50 | 78.500 | 68.500 |
| Removal speed (nm/min) | 800 | 700 | 40 | 30 | 24 | 32 |

| | | | |
|---|---|---|---|
| Avg. removal speed | 750 | 35 | 28 |
| (nm/min) | | | |

The copper polishing speed is relatively high during the initial polishing, where it can reach above 700 nm/min, which is higher than in systems employed by Fujimi, Rodel, Cabot, and DuPont (500-600 nm/min).

When approaching the end point of the copper layer, i.e., near to the barrier metal and the dielectric layer material, the polishing speed of the barrier material and the SiO₂ medium is relatively low, and the selection ratio of copper vs. tantalum and medium is relatively high (>20:1), which is suitable for production applications.

For the final polishing stage of Cu-CMP, the slurry characteristics are as follows: the SiO₂ sol abrasive particle size is 15 nm, the initial SiO₂ concentration is 40 wt. %, the proportion of SiO₂ abrasive to deionized water is 1:2, the FA/O I surfactant concentration is 50 ml/L of the slurry, the FA/O chelating agent concentration is 100 ml/L of the slurry, the pH ranges from 9.5 to 11.5, and the oxidant H₂O₂ concentration is 5 ml/L of the slurry. The polishing conditions are as follows: the pressure is 100 g/cm², the slurry flow is 4000 ml/min, the rotation speed is 60 rpm, the temperature is 25° C., the polishing speed ranges between 200-1100 nm/min, and the polishing time is 30-60 sec. The final polishing speeds are exemplified in Table 2.

TABLE 2
The final polishing speeds

| | #1 (Cu) | #2 (Cu) | #3 (Ta) | #4 (Ta) | #5 (SiO₂) |
|---|---|---|---|---|---|
| Before CMP (μm) | 178 | 145 | 189 | 138 | 160 |
| After-CMP (μm) | 177 | 143.9 | 188 | 137 | 159 |
| Removal speed (nm/ | 1000 | 1100 | 1000 | 1000 | 1000 |
| min) | | | | | |

| | | | |
|---|---|---|---|
| Avg. removal speed | 1050 | 1000 | 1000 |
| (nm/min) | | | |

During the final polishing, the tantalum polishing speed can exceed 700 nm/min. The polishing speed of the copper layer, the Ta barrier layer, and the SiO₂ dielectric layer are in substantial agreement, and selection ratio of copper, tantalum, and the SiO₂ medium is 1:1:1. The speed can be controlled according to the actual production requirements, and the dishing problem is controlled effectively.

### Example 2

The polishing slurry and the polishing condition of the initial polishing and the final polishing are as follows.

For the initial polishing stage of Cu-CMP, the slurry characteristics are as follows: the SiO₂ sol abrasive particle size is 20 nm, the initial SiO₂ concentration is 50 wt. %, the proportion of the SiO₂ abrasive to deionized water is 1:3, the FA/O I surfactant concentration is 80 ml/L of the slurry, the FA/O chelating agent concentration is 60 ml/L of the slurry, the pH is in the range from about 9.5 to about 11.5, and the oxidant H₂O₂ concentration is 30 ml/L of the slurry. The polishing conditions are as follows: the polishing pressure is 250 g/cm², the slurry flow is 200 ml/min, the rotation speed is 120 rpm, the temperature is 40° C., and the polishing time is 1-5 min.

For the final polishing stage of Cu-CMP, the slurry characteristics are as follows: the SiO₂ sol abrasive particle size is15 nm, the initial SiO₂ concentration is 40 wt. %, the proportion of the SiO₂ abrasive to deionized water is 1:2, the FA/O I surfactant concentration is 50 ml/L of the slurry, the FA/O chelating agent concentration is 100 ml/L of the slurry, the pH is in the range of from about 9.5 to about 11.5, and the oxidant H₂O₂ concentration is 15 ml/L of the slurry. The polishing conditions are: the pressure is 150 g/cm², the slurry flow is 2000 ml/min, the rotation speed is 80 rpm, the temperature is 20° C., and the polishing time is 30-60 sec. All other conditions are the same as in Example 1.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A method of chemical-mechanical planarization of copper multilayer interconnection structures and of controlling the dishing problem associated therewith comprising:
(a) preparing a slurry by (i) diluting SiO₂ hydrosol with deionized water; (ii) admixing a chelating agent and adjusting the pH to between 9.5 and 11.5; and (iii) admixing one or more surfactant(s) and one or more oxidant(s);
(b) applying said slurry to said copper multilayer interconnection structures; and
(c) polishing said copper multilayer interconnection structures with polishing pad(s).

2. The method of claim 1 wherein
said slurry is applied at a flow rate of between about 200 and 5000 ml/min;
said slurry has a temperature of 20-40° C.;
said polishing pad(s) rotate at between about 60 and 120 rpm; and
said polishing pad(s) deliver to said copper multilayer interconnection structures a pressure of between about 100 and 250 g/cm².

3. The method of claim 1 wherein copper multilayer interconnection structures are planarized at a rate of 200-1100 nm/min.

4. The method of claim 1 wherein a copper layer is polished for 1-5 minutes and then the copper, barrier, and dielectric layers are polished for 30-60 seconds.

5. The method of claim 1 wherein
said SiO₂ hydrosol has a particle diameter between about 15 and about 40 nm;
said SiO₂ hydrosol has an initial concentration of 20-50% by weight; and
said SiO₂ hydrosol is diluted with deionized water in a weight proportion of from about 1:1 to about 1:5.

6. The method of claim 1 wherein said chelating agent is EDTA·4 3,4-diaminobutane-1,1,2,2-tetraol of Formula III:

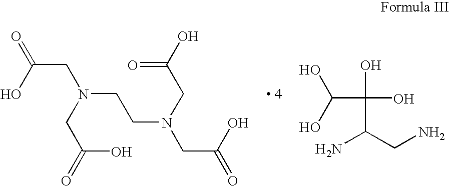

7. The method of claim 1 wherein said chelating agent is present in the slurry in a volume ratio of between 0.5 to 10% with respect to the slurry.

8. The method of claim 1 wherein said surfactant is a surfactant selected from the group consisting of an FA/O surfactant, a JFC surfactant, an AEO surfactant, a fatty amine ethoxylate surfactant, a fatty alkanolamide surfactant, or derivatives thereof; and said surfactant is present in the slurry in a volume ratio of between 0.5 to 10% with respect to the slurry.

9. The method of claim 1 wherein said surfactant is a compound of general Formula I or Formula II, 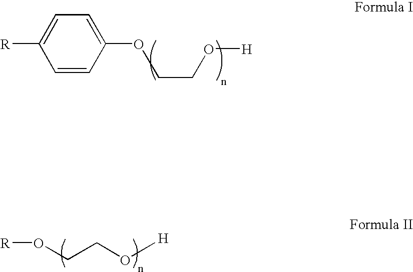
wherein R is an alkyl, and n is an integer greater than 5.

10. The method of claim 1 wherein said oxidant is H₂O₂; and said oxidant is present in the slurry in a volume ratio of between 0.5 and 10% with respect to the slurry.

11. A method of chemical-mechanical planarization of copper multilayer interconnection structures and of controlling the dishing problem associated therewith comprising:
(a) preparing a slurry by (i) diluting SiO₂ hydrosol with deionized water; (ii) admixing a compound of Formula III 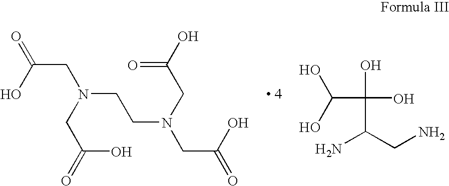
and adjusting the pH to between 9.5 and 11.5; and (iii) admixing a compound of Formula I, 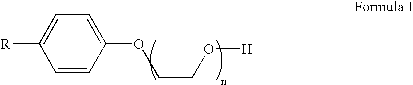
wherein R is decyl and n is 7, and admixing aqueous H₂O₂;
(b) applying said slurry to said copper multilayer interconnection structures; and
(c) polishing said copper multilayer interconnection structures with polishing pad(s).

12. The method of claim 11 wherein
said slurry is applied at a flow rate of between about 200 and 5000 ml/min;
said slurry has a temperature of 20-40° C.;
said polishing pad(s) rotate at between about 60 and 120 rpm; and
said polishing pad(s) deliver to said copper multilayer interconnection structures a pressure of between about 100 and 250 g/cm².

13. The method of claim 11 wherein copper multilayer interconnection structures are planarized at a rate of 200-1100 nm/min.

14. The method of claim 11 wherein a copper layer is polished for 1-5 minutes and then the copper, barrier, and dielectric layers are polished for 30-60 seconds.

15. The method of claim 11 wherein
said SiO₂ hydrosol has a particle diameter between about 15 and about 40 nm;
said SiO₂ hydrosol has an initial concentration of 20-50% by weight; and
said SiO₂ hydrosol is diluted with deionized water in a weight proportion of from about 1:1 to about 1:5.

16. The method of claim 11 wherein said chelating agent is is EDTA·4 3,4-diaminobutane-1,1,2,2-tetraol of Formula III:

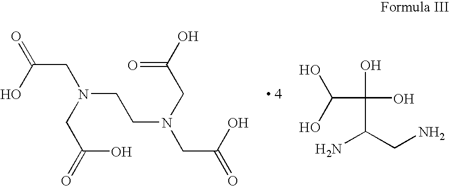

17. The method of claim 11 wherein said chelating agent is present in the slurry in a volume ratio of between 0.5 to 10% with respect to the slurry.

18. The method of claim 11 wherein said surfactant is a compound of general Formula I or Formula II, 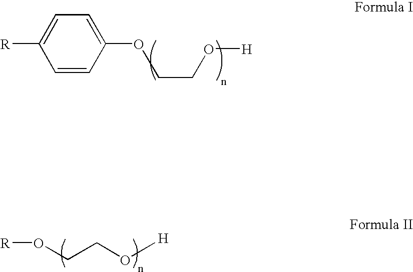
wherein R is an alkyl, and n is an integer greater than 5.

19. The method of claim 11 wherein said oxidant is H₂O₂; and said oxidant is present in the slurry in a volume ratio of between 0.5 and 10% with respect to the slurry.

20. A polishing slurry for chemical-mechanical planarization of copper multilayer interconnection structures prepared by the following steps:
(i) diluting SiO₂ hydrosol with deionized water;
(ii) admixing a compound of Formula III 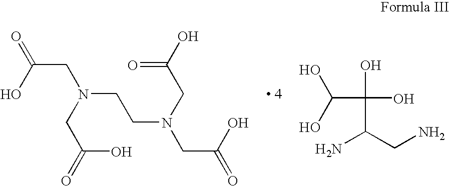
and adjusting the pH to between 9.5 and 11.5; and
(iii) admixing a compound of Formula I, 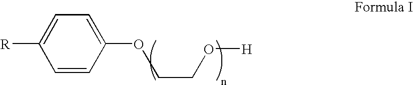
wherein R is decyl and n is 7, and admixing aqueous H₂O₂.
